(19) United States
(12) Patent Application Publication
(10) Pub. No.: US 2023/0382440 A1
(43) Pub. Date: Nov. 30, 2023

(54) BRAKE DEVICE FOR RAILWAY VEHICLE

(71) Applicant: Nabtesco Corporation, Tokyo (JP)

(72) Inventor: Takashi UTSUMI, Tokyo (JP)

(21) Appl. No.: 18/298,447

(22) Filed: Apr. 11, 2023

(30) Foreign Application Priority Data
May 24, 2022 (JP) 2022-084473

(51) Int. Cl. B61H 13/22; B60T 13/74; F16D 65/18; B61H 5/00; B61H 13/34

(52) U.S. Cl. CPC B61H 13/22; B60T 13/746; F16D 65/18; B61H 5/00; B61H 13/34; B60T 2270/402; B60T 2270/414; F16D 2127/06

(57) ABSTRACT

A brake device for a railway vehicle includes: a regular electric motor having a rotatable regular-side rotor; a transmission shaft member extending from the regular electric motor in the direction of the rotation axis of the regular-side rotor and rotated by the rotational force output from the regular-side rotor; a conversion mechanism attached to the transmission shaft member and configured to convert the rotational motion of the transmission shaft member into linear motion; friction members configured to receive the linear motion to be pressed against a brake-applied member of the railway vehicle, so as to brake the railway vehicle; and a security power unit attached to the transmission shaft member and configured to output the rotational force to the transmission shaft member.

### CROSS-REFERENCE TO RELATED APPLICATIONS

This application is based on and claims the benefit of priority from Japanese Patent Application Serial No. 2022-084473 (filed on May 24, 2022), the contents of which are hereby incorporated by reference in their entirety.

### TECHNICAL FIELD

The present invention relates to a brake device for a railway vehicle.

### BACKGROUND

Electric brake devices are conventionally known as brake devices for vehicles that brake a vehicle by driving of an electric motor. For example, the electric brake device disclosed in German Patent Application Publication No. 19907958 includes a transmission shaft member for transmitting a braking force and two electric motors for driving the transmission shaft member. The input from the two electric motors to the transmission shaft member is mediated by a gear mechanism such as gears.

Since one transmission shaft member is operated by two electric motors, the brake function can be maintained in the event of a failure of one of the electric motors, but not in the event of power loss. In addition, the input from the electric motors to the transmission shaft member is mediated by a gear mechanism such as gears. This configuration probably reduces the transmission efficiency for the driving force of the electric motors transmitted to a friction member.

### SUMMARY

The present invention addresses the above problems. The object of the present invention is to provide a brake device for a railway vehicle capable of achieving redundancy of the brake device for a railway vehicle and having an improved response of the braking force and an improved transmission efficiency for the driving force of a regular electric motor and a security power unit transmitted to a friction member.

To overcome the above problem, aspects of the present invention are configured as follows. (1) A brake device for a railway vehicle according to an aspect of the present invention comprises: a regular electric motor including a regular-side rotor capable of rotating; a transmission shaft member extending from the regular electric motor in a direction of a rotation axis of the regular-side rotor and configured to be rotated by a rotational force output from the regular-side rotor; a conversion mechanism attached to the transmission shaft member and configured to convert rotational motion of the transmission shaft member into linear motion; a friction member configured to receive the linear motion to be pressed against a brake-applied member of a railway vehicle, so as to brake the railway vehicle; and a security power unit attached to the transmission shaft member and configured to output a rotational force to the transmission shaft member.

With this configuration, the regular electric motor and the security power unit are provided to achieve the redundancy of the brake device for a railway vehicle. In addition, only one transmission shaft member is needed to transmit the output of the regular electric motor and the security power unit to the conversion mechanism. Therefore, as compared to the case where a gear mechanism including gears is interposed, there is no effect of backlash and inertia of the gear mechanism. This makes it possible to improve the response of the braking force and the transmission efficiency for the driving force of the regular electric motor and the security power unit transmitted to the friction member.

(2) In the brake device for a railway vehicle according to (1) above, it is also possible that the transmission shaft member extends from the regular electric motor in two coaxial directions, and the conversion mechanism and the security power unit are arranged coaxially with the transmission shaft member and located on opposite sides across the regular electric motor.

(3) The brake device for a railway vehicle according to (1) or (2) above may further comprise: a clutch configured to switch between a transmission state in which a rotational force of the security power unit is transmitted to the transmission shaft member and a non-transmission state in which a rotational force of the security power unit is not transmitted to the transmission shaft member, wherein the clutch may be provided between the regular electric motor and the security power unit.

(4) In the brake device for a railway vehicle according to (3) above, it is also possible that the security power unit is a motor including a security-side rotor having a hollow structure and configured to output a rotational force, and the clutch is coupled to the security-side rotor and the transmission shaft member.

(5) In the brake device for a railway vehicle according to (3) or (4) above, it is also possible that the clutch is an electromagnetic clutch including a clutch-side rotor and an armature capable of moving relative to the clutch-side rotor, the clutch being configured to switch between a contact state in which the armature is in contact with the clutch-side rotor and a non-contact state in which the armature is not in contact with the clutch-side rotor, and the security-side rotor is fixed to the armature.

(6) In the brake device for a railway vehicle according to (5) above, it is also possible that the clutch-side rotor has a smaller weight than the security-side rotor.

(7) In the brake device for a railway vehicle according to any one of (1) to (6) above, it is also possible that the regular-side rotor has a hollow structure, and the transmission shaft member extends through the regular-side rotor having a hollow structure, and the transmission shaft member is coupled with the regular-side rotor to be driven.

(8) The brake device for a railway vehicle according to any one of (1) to (7) above may further comprise: an electromagnetic brake for retaining a braking force, wherein the electromagnetic brake may be provided between the regular electric motor and the security power unit.

(9) The brake device for a railway vehicle according to any one of (1) to (8) above may further comprise: a clutch configured to switch between a transmission state in which a rotational force of the security power unit is transmitted to the transmission shaft member and a non-transmission state in which a rotational force of the security power unit is not transmitted to the transmission shaft member, wherein the clutch may be an electromagnetic clutch including a clutch-side rotor and an armature capable of moving relative to the clutch-side rotor, the clutch being configured to switch between a contact state in which the armature is in contact with the clutch-side rotor and a non-contact state in which the armature is not in contact with the clutch-side rotor, and wherein the transmission shaft member extending from the regular electric motor may be fixed to the clutch-side rotor.

(10) The brake device for a railway vehicle according to any one of (1) to (9) above may further comprise: a clutch configured to switch between a transmission state in which a rotational force of the security power unit is transmitted to the transmission shaft member and a non-transmission state in which a rotational force of the security power unit is not transmitted to the transmission shaft member, wherein the clutch may be an electromagnetic clutch including a clutch-side rotor and an armature capable of moving relative to the clutch-side rotor, the clutch being configured to switch between a contact state in which the armature is in contact with the clutch-side rotor and a non-contact state in which the armature is not in contact with the clutch-side rotor, and wherein the security power unit may be fixed to the armature.

(11) The brake device for a railway vehicle according to any one of (1) to (10) above may further comprise: an input gear configured to receive an output of the regular electric motor; and a speed reducer configured to receive rotation of the input gear and output a decelerated rotational force to the conversion mechanism, wherein the transmission shaft member extending from the regular electric motor may be fixed to the input gear.

(12) In the brake device for a railway vehicle according to any one of (1) to (11) above, it is also possible that the transmission shaft member is a shaft fixed to the regular-side rotor, the brake device further comprises: an input gear fixed to the shaft extending from the regular electric motor, the input gear being configured to receive an output of the regular electric motor; and a speed reducer including an output rotator configured to receive rotation of the input gear and output a decelerated rotational force, and the conversion mechanism includes: a male screw serving as an input rotator configured to receive a rotational force output from the output rotator; a female screw meshing with the male screw, the female screw serving as a linear motion member configured to convert rotational motion of the male screw into the linear motion; and an arm configured to transmit to the friction member the linear motion output from the female screw.

(13) In the brake device for a railway vehicle according to any one of (1) to (11) above, it is also possible that the transmission shaft member is a coupling unit having a tubular shape and fixed to the regular-side rotor, the brake device further comprises: an input gear fixed to the coupling unit extending from the regular electric motor, the input gear being configured to receive an output of the regular electric motor; and a speed reducer including an output rotator configured to receive rotation of the input gear and output a decelerated rotational force, and the conversion mechanism includes: a female screw serving as an input rotator configured to receive a rotational force output from the output rotator; a male screw meshing with the female screw, the male screw serving as a linear motion member configured to convert rotational motion of the female screw into the linear motion; and an arm configured to transmit to the friction member the linear motion output from the male screw.

### Advantageous Effects

The present invention provides a brake device for a railway vehicle capable of achieving redundancy of the brake device for a railway vehicle and having an improved response of the braking force and an improved transmission efficiency for the driving force of a regular electric motor and a security power unit transmitted to a friction member.

### BRIEF DESCRIPTION OF THE DRAWINGS

FIG. 1 is a block diagram showing a brake device for a railway vehicle according to a first embodiment.

FIG. 2 is a cross-sectional perspective view schematically showing the brake device for a railway vehicle according to the first embodiment.

FIG. 3 is a cross-sectional perspective view showing a shaft of the first embodiment and surrounding parts.

FIG. 4 is a first diagram for illustrating operation of an electromagnetic clutch of the first embodiment.

FIG. 5 is a second diagram for illustrating operation of the electromagnetic clutch of the first embodiment.

FIG. 6 is a block diagram showing a brake device for a railway vehicle according to a second embodiment.

FIG. 7 is a cross-sectional perspective view schematically showing a brake device for a railway vehicle according to a third embodiment.

FIG. 8 is a cross-sectional perspective view showing a coupling unit of the third embodiment and surrounding parts.

### DESCRIPTION OF THE PREFERRED EMBODIMENTS

Embodiments of the present invention will now be described with reference to the attached drawings. The following description of the embodiments will be based on a brake device for a railway vehicle as an example of an electric brake device. In the following description, terms such as “parallel,” “orthogonal,” “around” and “coaxial” describe relative or absolute positions. These terms are not only strictly used but also allow some tolerances and relative differences in angle and distance as long as the same effects can be still produced. In the drawings used for the following description, members are shown to different scales into recognizable sizes.

### First Embodiment

<Brake Device for Railway Vehicle>

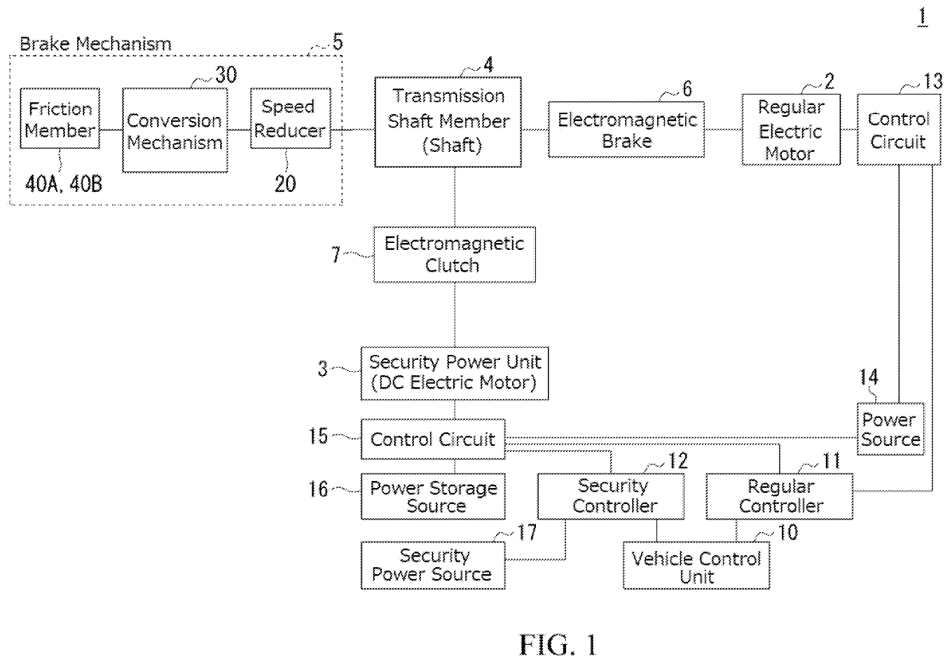

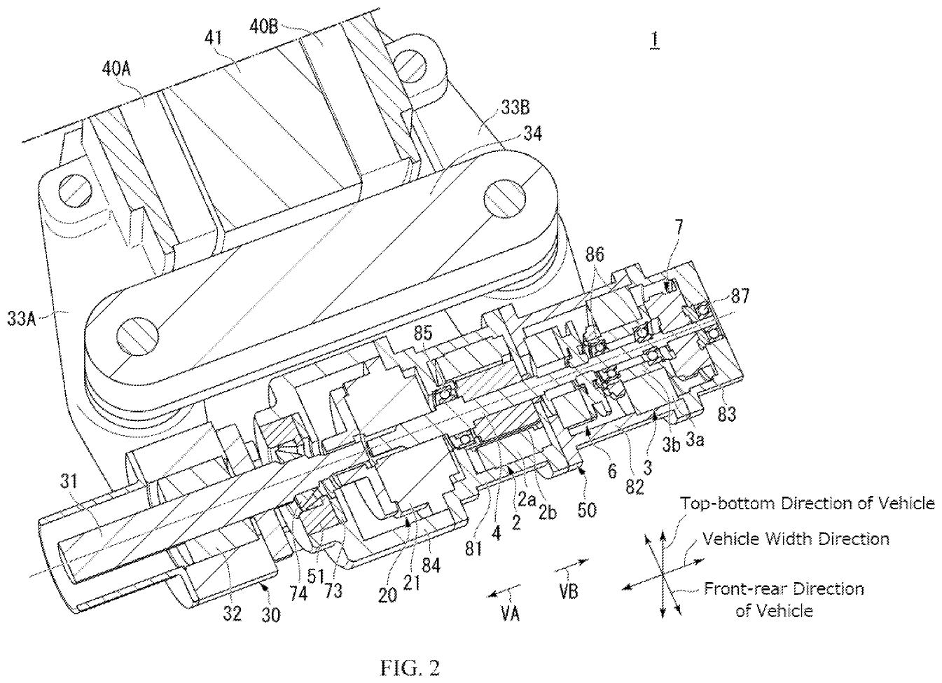

FIG. 1 is a block diagram showing a brake device 1 for a railway vehicle according to a first embodiment. FIG. 2 is a cross-sectional perspective view schematically showing the brake device 1 for a railway vehicle according to the first embodiment. In FIG. 2, the top-bottom direction of the vehicle refers to the top-bottom direction (height direction) of the railway vehicle, the front-rear direction of the vehicle refers to the front-rear direction of the railway vehicle, and the vehicle width direction refers to the width direction of the railway vehicle.

As shown in FIG. 1, the brake device 1 for a railway vehicle includes a regular electric motor 2, a security power unit 3, a transmission shaft member 4, a brake mechanism 5, an electromagnetic brake 6, an electromagnetic clutch 7 (an example of a clutch), a vehicle control unit 10, a regular controller 11, and a security controller 12.

In the present embodiment, the regular electric motor 2 is an AC electric motor. The regular electric motor 2 includes a regular-side rotor 2b capable of rotating. The security power unit 3 is a DC electric motor (an example of a motor). The security power unit 3 includes a security-side rotor 3b having a hollow structure and configured to output a rotational force. The security power unit 3, which is an electric motor, is hereinafter also referred to as “security electric motor 3.” The transmission shaft member 4 is a shaft 4 fixed to the regular-side rotor 2b. The transmission shaft member 4 is hereinafter also referred to as “shaft 4.” The brake mechanism 5 includes a speed reducer 20, a conversion mechanism 30, and friction members 40A and 40B.

The vehicle control unit 10 provides overall control of the components of the railway vehicle. For example, the vehicle control unit 10 controls the regular controller 11 and the security controller 12. A control circuit 13 such as an inverter is connected to the regular electric motor 2. For example, the regular controller 11 controls the rotational drive of the regular electric motor 2 via the control circuit 13. A control circuit 15 such as an inverter is connected to the security electric motor 3. For example, the regular controller 11 controls the rotational drive of the security electric motor 3 via the control circuit 15. The control circuits 13 and 15 are connected to a power source 14.

For example, the security controller 12 controls the rotational drive of the security electric motor 3 via the control circuit 15. The control circuit 15 is connected to a power storage source 16. The power storage source 16 is a drive energy source for the security braking and the parking braking in the event of power loss. For example, the power storage source 16 is a lithium ion storage battery or a capacitor. A security power source 17 is connected to the security controller 12.

As shown in FIG. 2, the regular electric motor 2 is disposed along the vehicle width direction. The regular electric motor 2 includes a regular-side stator 2a having a tubular shape and a regular-side rotor 2b capable of rotating relative to the regular-side stator 2a. The regular-side rotor 2b is located on the radially inner side of the regular-side stator 2a. The regular electric motor 2 is an inner-rotor motor.

The shaft 4 extends from the regular electric motor 2 in the direction of the rotation axis of the regular-side rotor 2b. The shaft 4 is rotated by the rotational force output from the regular-side rotor 2b. The shaft 4 extends from the regular electric motor 2 in two coaxial directions. The two directions correspond to one direction in the vehicle width direction (the direction toward one side in the vehicle width direction) and the other direction in the vehicle width direction (the direction toward the other side in the vehicle width direction). The regular-side rotor 2b has a hollow structure. The shaft 4 extends through the regular-side rotor 2b having a hollow structure. The axially central portion of the shaft 4 is fixed to the regular-side rotor 2b. The shaft 4 is driven since it is coupled to the regular-side rotor 2b.

The security electric motor 3 has a smaller size than the regular electric motor 2. The security electric motor 3 is disposed along the vehicle width direction. The security electric motor 3 is mounted to the shaft 4. The security electric motor 3 outputs a rotational force to the shaft 4. The security electric motor 3 and the regular electric motor 2 are coaxial with each other.

The security electric motor 3 includes a security-side stator 3a having a tubular shape and a security-side rotor 3b capable of rotating relative to the security-side stator 3a. The security-side rotor 3b is located on the radially inner side of the security-side stator 3a. The security electric motor 3 is an inner-rotor motor.

The electromagnetic brake 6 is an electromagnetic brake for retaining a braking force. The electromagnetic brake 6 is provided between the regular electric motor 2 and the security electric motor 3. The electromagnetic brake 6 can lock the rotation of the regular electric motor 2. For example, the electromagnetic brake 6 is a mechanism such as a non-excited electromagnetic clutch (brake), torque diode, or one-way clutch.

The electromagnetic clutch 7 switches between a transmission state in which the rotational force of the security electric motor 3 is transmitted to the shaft 4 and a non-transmission state in which the rotational force of the security electric motor 3 is not transmitted to the shaft 4. The electromagnetic clutch 7 is provided between the regular electric motor 2 and the security electric motor 3. For example, the electromagnetic clutch 7 is a non-excited electromagnetic clutch (brake).

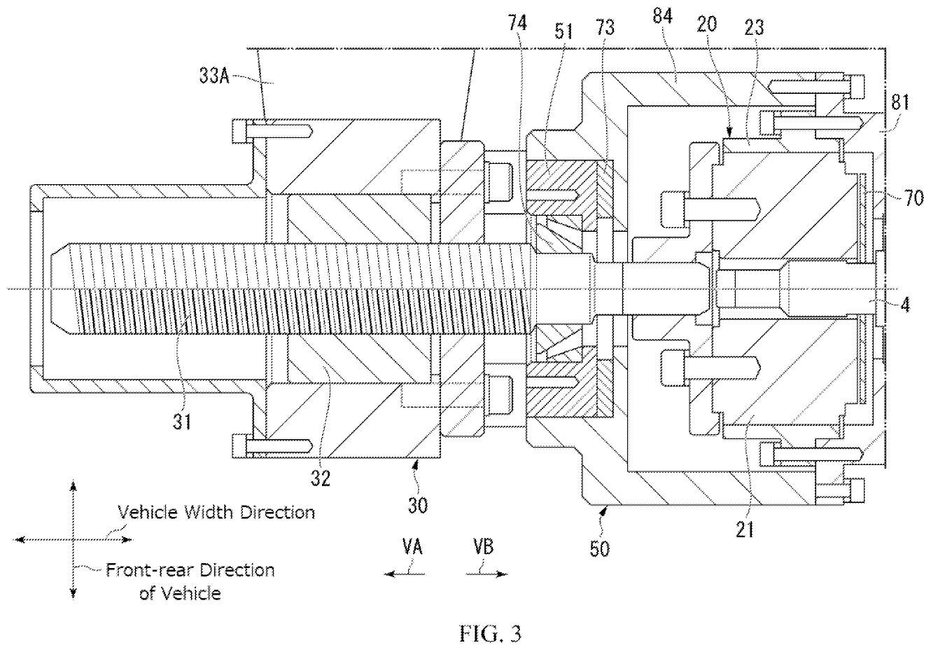

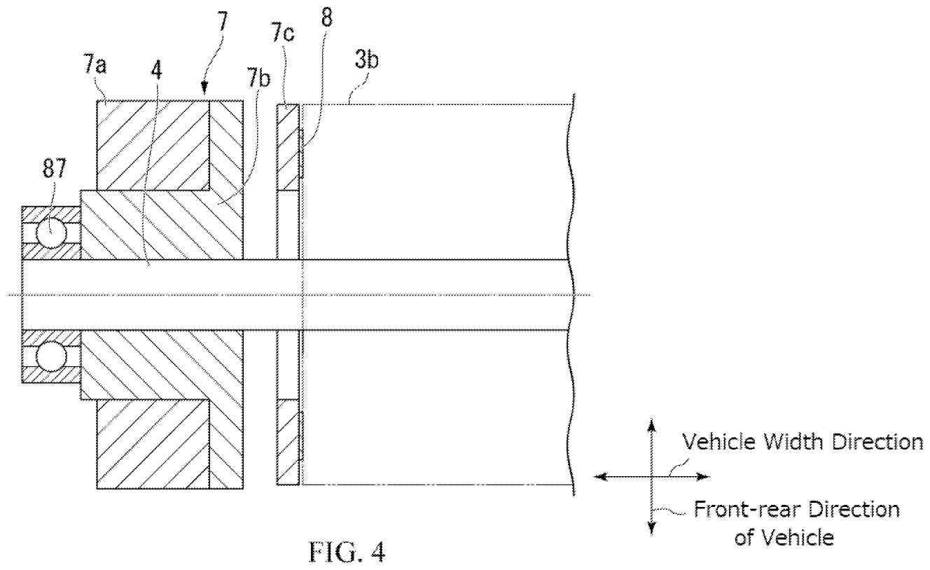

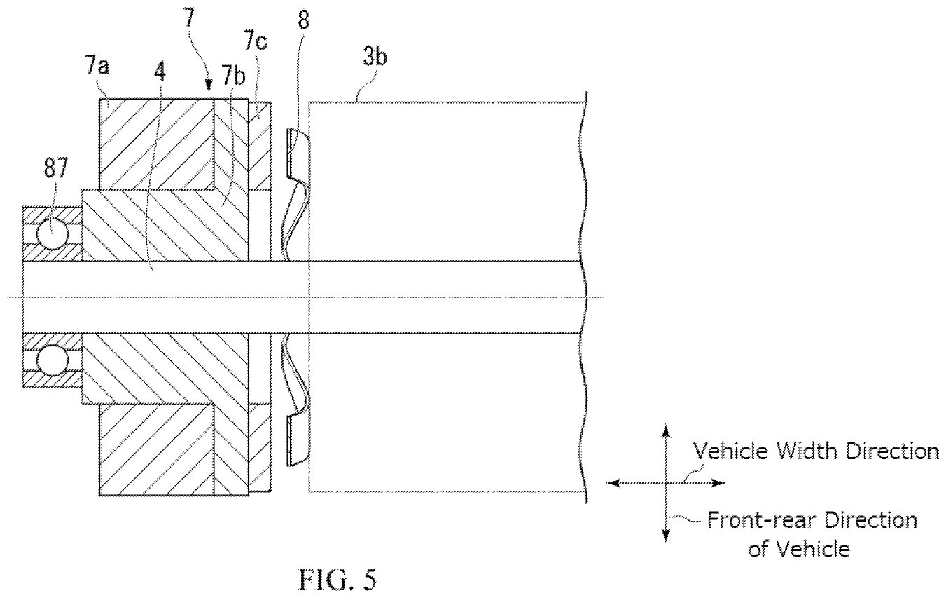

FIG. 3 is a cross-sectional perspective view showing the shaft 4 of the first embodiment and surrounding parts. FIG. 4 is a first diagram for illustrating operation of the electromagnetic clutch 7 of the first embodiment. FIG. 5 is a second diagram for illustrating operation of the electromagnetic clutch 7 of the first embodiment. FIG. 4 is an illustration of operation performed during normal braking (when the power is off). FIG. 5 is an illustration of operation performed during security braking (when the power is on).

As shown in FIG. 3, an input gear 70 to which the output of the regular electric motor 2 is input is fixed to the shaft 4 extending from the regular electric motor 2. The speed reducer 20 receives the rotation of the input gear 70 and outputs a decelerated rotational force to the conversion mechanism 30. The speed reducer 20 includes an output rotator 21 that receives the rotation of the input gear 70 and outputs a decelerated rotational force. The output rotator 21 has a hollow structure. The output rotator 21 has a tubular shape extending along the vehicle width direction. For example, the speed reducer 20 is a precision speed reducer with a hollow structure. For example, the speed reducer 20 includes an eccentric oscillation gear mechanism. The speed reducer 20 includes a tubular case 23 that rotatably retains the input gear 70.

As described above, the security electric motor 3 includes a security-side rotor 3b having a hollow structure and configured to output a rotational force. As shown in FIG. 4, the electromagnetic clutch 7 is coupled to the security-side rotor 3b and the shaft 4. The electromagnetic clutch 7 includes a clutch-side stator 7a having a tubular shape, a clutch-side rotor 7b that can rotate relative to the clutch-side stator 7a, and an armature 7c that can move relative to the clutch-side rotor 7b.

The shaft 4 extending from the regular electric motor 2 is fixed to the clutch-side rotor 7b. The clutch-side rotor 7b is fixed to a portion of the shaft 4 closer to the end opposite to the speed reducer 20 in the axial direction of the shaft 4. The clutch-side rotor 7b has a smaller size than the security-side rotor 3b. The clutch-side rotor 7b has a smaller weight than the security-side rotor 3b. The armature 7c is provided between the clutch-side rotor 7b and the security-side rotor 3b.

An elastic member 8 is provided between the security-side rotor 3b and the armature 7c. The elastic member 8 has an elastic force that attracts the armature 7c to the security-side rotor 3b. An example of the elastic member 8 is a plate spring. Another example of the elastic member 8 is a coil spring. For example, the elastic member 8 can be configured in various manners in accordance with required specifications.

The electromagnetic clutch 7 switches between a contact state in which the armature 7c is in contact with the clutch-side rotor 7b and a non-contact state in which the armature 7c is not in contact with the clutch-side rotor 7b. In the contact state, the security-side rotor 3b is fixed to the armature 7c.

FIG. 4 shows the non-contact state in which the armature 7c is not in contact with the clutch-side rotor 7b during normal braking (when the power is off). In FIG. 4, the gap between the clutch-side rotor 7b and the armature 7c is exaggerated. FIG. 5 shows the contact state in which the armature 7c is in contact with the clutch-side rotor 7b during security braking (when the power is on).

For example, as shown in FIG. 5, when the power is turned on, the coil built into the clutch-side stator 7a becomes electrically charged. The clutch-side stator 7a then emits a magnetic force. The magnetic force emitted from the clutch-side stator 7a attracts the armature 7c to the clutch-side rotor 7b. When the power is on, the armature 7c is attracted to the clutch-side rotor 7b against the elastic force of the elastic member 8 (the force that attracts the armature 7c to the security-side rotor 3b). When the power is on, the transmission state is entered in which the rotational force of the security-side rotor 3b of the security electric motor 3 is transmitted to the shaft 4.

For example, as shown in FIG. 4, when the power is turned off, the magnetic circuit of the clutch-side stator 7a disappears. Then there is no longer the force to attract the armature 7c to the clutch-side rotor 7b. The armature 7c is attracted to the security-side rotor 3b by the elastic force of the elastic member 8. As a result, the armature 7c returns to its original position, and the electromagnetic clutch 7 is released. When the power is off, the transmission of the rotational force of the security-side rotor 3b is interrupted. In other words, when the power is off, the non-transmission state is entered in which the rotational force of the security-side rotor 3b of the security electric motor 3 is not transmitted to the shaft 4.

As shown in FIG. 2, the conversion mechanism 30 is mounted to the shaft 4. The conversion mechanism 30 converts the rotational motion of the shaft 4 into linear motion. As described above, the shaft 4 extends from the regular electric motor 2 in two coaxial directions. The conversion mechanism 30 and the security electric motor 3 are arranged coaxially with the shaft 4. The conversion mechanism 30 and the security electric motor 3 are located on opposite sides across the regular electric motor 2.

The conversion mechanism 30 includes an input rotator 31 to which the rotational force output from the output rotator 21 is input, a linear motion member 32 that converts the rotational motion of the input rotator 31 into linear motion, and arms 33A and 33B that transmit the linear motion generated through conversion by the linear motion member 32 to the friction members 40A and 40B. The linear motion member 32 converts the rotational motion of the input rotator 31 into linear motion in the moving directions VA and VB parallel to the rotation axis of the input rotator 31. In this embodiment, the conversion mechanism 30 is a ball screw mechanism. The input rotator 31 is a male screw 31. The linear motion member 32 is a female screw 32 that meshes with the male screw 31.

A pair of friction members 40A and 40B are arranged in the vehicle width direction so as to sandwich a brake-applied member 41 of the railway vehicle. The linear motion of the female screw 32 in the moving directions VA and VB is transmitted to the friction members 40A and 40B. As a result, the friction members 40A and 40B are pressed against the brake-applied member 41 to brake the railway vehicle.

The brake-applied member 41 is a disc attached to the axle of the railway vehicle. The pair of friction members 40A and 40B constitute a disc brake unit (DBU) that sandwiches the disc on both sides. Of the pair of friction members 40A and 40B, the friction member 40A on one side in the vehicle width direction is hereinafter also referred to as “the first friction member 40A,” and the friction member 40B on the other side in the vehicle width direction as “the second friction member 40B.”

The brake device 1 for a railway vehicle includes a housing 50 that houses the shaft 4, the conversion mechanism 30 and other components so that the female screw 32 can move in the moving directions VA and VB. The housing 50 houses the portions of the shaft 4 and the conversion mechanism 30 on one side in the vehicle width direction.

The housing 50 is constituted by a plurality of cover members 81, 82, 83, 84 coupled together. The plurality of cover members 81, 82, 83, 84 include a first cover member 81 that houses the regular electric motor 2, a second cover member 82 that houses the security electric motor 3 and the electromagnetic brake 6, a third cover member 83 that houses the electromagnetic clutch 7, and a fourth cover member 84 that houses the speed reducer 20.

The first cover member 81 is positioned between the second cover member 82 and the fourth cover member 84. The first cover member 81 is coupled to the fourth cover member 84. A first bearing 85 is provided between the first cover member 81 and the shaft 4. The first bearing 85 is located between the regular electric motor 2 and the speed reducer 20.

The second cover member 82 is positioned between the first cover member 81 and the third cover member 83. The second cover member 82 is coupled to the first cover member 81. A pair of second bearings 86 are provided between the second cover member 82 and the shaft 4. The pair of second bearings 86 are located between the security electric motor 3 and the shaft 4.

The third cover member 83 is positioned on the opposite side to the first cover member 81 with respect to the second cover member 82. The third cover member 83 is coupled to the second cover member 82. A third bearing 87 is provided between the third cover member 83 and the shaft 4. The third bearing 87 is located at the end of the shaft 4 on the opposite side to the end on the male screw 31 side.

The conversion mechanism 30 includes the arms 33A and 33B that transmit the linear motion, which is the output of the female screw 32, to the friction members 40A and 40B. The conversion mechanism 30 includes a pair of arms 33A and 33B spaced apart in the vehicle width direction and a coupling member 34 that couples the pair of arms 33A and 33B. Of the pair of arms 33A and 33B, the arm 33A on one side in the vehicle width direction is hereinafter also referred to as “the first arm 33A,” and the arm 33B on the other side in the vehicle width direction as “the second arm 33B.”

The first arm 33A extends along the front-rear direction of the vehicle so as to connect between the female screw 32 and the first friction member 40A. The first arm 33A has a length along the front-rear direction of the vehicle. One end of the first arm 33A in its longitudinal direction is coupled to the female screw 32 so as to be rotatable relative to the female screw 32 about an axis along the top-bottom direction of the vehicle. The other end of the first arm 33A in its longitudinal direction is coupled to the first friction member 40A so as to be rotatable relative to the first friction member 40A about an axis along the top-bottom direction of the vehicle.

The second arm 33B extends along the front-rear direction of the vehicle so as to connect between the housing 50 (e.g., the second cover member 82) and the second friction member 40B. The second arm 33B has a length along the front-rear direction of the vehicle. One end of the second arm 33B in its longitudinal direction is coupled to the housing 50 (e.g., the second cover member 82) so as to be rotatable relative to the housing 50 about an axis along the top-bottom direction of the vehicle. The other end of the second arm 33B in its longitudinal direction is coupled to the second friction member 40B so as to be rotatable relative to the second friction member 40B about an axis along the top-bottom direction of the vehicle.

The coupling member 34 extends along the vehicle width direction so as to connect between the pair of arms 33A and 33B. The coupling member 34 has a length along the vehicle width direction. One end of the coupling member 34 in its longitudinal direction is coupled to the middle portion of the first arm 33A in its longitudinal direction so as to be rotatable relative to this middle portion of the first arm 33A about an axis along the top-bottom direction of the vehicle. The other end of the coupling member 34 in its longitudinal direction is coupled to the middle portion of the second arm 33B in its longitudinal direction so as to be rotatable relative to this middle portion of the second arm 33B about an axis along the top-bottom direction of the vehicle.

The brake device 1 for a railway vehicle includes a reaction force receiving member 51 that receives the reaction force acting on the male screw 31 when the friction members 40A and 40B are pressed against the brake-applied member 41. The reaction force receiving member 51 is provided between the fourth cover member 84 of the housing 50 and the portion of the male screw 31 close to its end in one of the moving directions VA and VB (indicated by the arrow VB in the drawing) opposite to the direction for pressing the friction members 40A and 40B against the brake-applied member 41. The end of the male screw 31 in the direction VB indicated by the arrow in the drawing is fixed to the output rotator 21. The male screw 31 is capable of transmitting the rotational motion of the output rotator 21 to the female screw 32. The reaction force receiving member 51 is provided on the portion of the male screw 31 close to its end that penetrates into the fourth cover member 84 of the housing 50.

As shown in FIG. 3, the housing 50 covers the input gear 70 from one side in the vehicle width direction. The case 23 of the speed reducer 20 is fixed to the housing 50 with bolts or other fastening members. The housing 50 receives the thrust from the male screw 31 and transmits the braking force. The housing 50 encloses a spacer 73 provided between the housing 50 and the reaction force receiving member 51 and a tapered roller bearing 74 provided between the reaction force receiving member 51 and the male screw 31.

For example, the spacer 73 is a slide bearing or a thrust bearing. The reaction force receiving member 51 receives thrust from the male screw 31 via the tapered roller bearing 74. The outer ring of the tapered roller bearing 74 is fixed to the reaction force receiving member 51 to allow the tapered roller bearing 74 to rotate with low friction while receiving a thrust load.

The housing 50 receives the thrust (ball screw reaction force) from the male screw 31 via the reaction force receiving member 51 and the tapered roller bearing 74. This prevents the thrust load from being applied to the speed reducer.

For example, when the output of the regular electric motor 2 is input to the input gear 70, a decelerated rotational force is output from the output rotator 21 of the speed reducer 20. The rotational force output from the output rotator 21 is then input to the male screw 31. As described above, the rotational motion of the male screw 31 is converted into linear motion of the female screw 32 in the moving directions VA and VB.

As shown in FIG. 2, the linear motion of the female screw 32 in the moving directions VA and VB is transmitted to the friction members 40A and 40B via the arms 33A and 33B and the coupling member 34. The arms 33A and 33B move in such a direction that the ends thereof coupled to the friction members 40A and 40B come closer to each other using the coupling member 34 as a fulcrum. As a result, the friction members 40A and 40B are pressed against the brake-applied member 41. Thus, the railway vehicle is braked.

<Example of Braking Operation>

Next, an example of braking operation of the brake device for a railway vehicle according to the embodiment is described with reference to FIG. 1 and other drawings.

<Normal Braking>

In the normal braking operation, the regular electric motor 2 is driven. In the normal braking operation, the power source 14 supplies power to the control circuit 13 for the regular electric motor 2. In the normal braking operation, the electromagnetic clutch 7 is turned off. In the normal braking operation, the security electric motor 3 is not driven.

When the regular electric motor 2 is driven, the electromagnetic brake 6 is turned off. When the regular electric motor 2 is driven, the electromagnetic brake 6 does not lock the rotation of the regular electric motor 2. The regular electric motor 2 is capable of forward and reverse rotation with the supplied electric power. The forward rotation of the regular electric motor 2 is the rotation in one direction around the rotation axis of the regular-side rotor 2b. The reverse rotation of the regular electric motor 2 is in the opposite direction to the forward rotation of the regular electric motor 2.

The forward and reverse rotation of the regular electric motor 2 is transmitted to the brake mechanism 5 through the shaft 4. For example, in the normal braking operation, forward rotation of the regular electric motor 2 tightens the braking, and reverse rotation thereof loosens the braking. The tightening of the braking refers to application of a braking force, and the loosening of the braking refers to release of the braking force.

In the normal braking operation, to retain the braking (such as for parking braking), the regular electric motor 2 is stopped with a predetermined amount of braking force applied. In the normal braking operation, to retain the braking, the electromagnetic brake 6 is turned on. This locks the rotation of the regular electric motor 2.

<Security Braking>

In the security braking operation, the security electric motor 3 is driven. In the security braking operation, the power storage source 16 supplies power to the control circuit 15 for the security electric motor 3. In the security braking operation, the electromagnetic clutch 7 is turned on. In the security braking operation, the regular electric motor 2 is not driven. In the security braking operation, the power source 14 does not supply power to the control circuit 13 for the regular electric motor 2.

When the security electric motor 3 is driven, the electromagnetic brake 6 is turned off. When the security electric motor 3 is driven, the electromagnetic brake 6 does not lock the rotation of the regular electric motor 2. The security electric motor 3 is capable of forward or reverse rotation with the supplied electric power. The forward rotation of the security electric motor 3 is the rotation in one direction around the rotation axis of the security-side rotor 3b. The reverse rotation of the security electric motor 3 is in the opposite direction to the forward rotation of the security electric motor 3.

The forward or reverse rotation of the security electric motor 3 is transmitted to the brake mechanism 5 through the electromagnetic clutch 7 and the shaft 4. For example, in the security braking operation, forward or reverse rotation of the security electric motor 3 tightens the braking (applies the braking force).

In the security braking operation, to retain the braking (such as for parking braking), the security electric motor 3 is stopped with a predetermined amount of braking force applied. In the security braking operation, to retain the braking, the electromagnetic brake 6 is turned on. This locks the rotation of the regular electric motor 2.

<Parking Braking>

In the operation of loosening the parking braking, the security electric motor 3 may be driven (security loosening). In the security loosening operation, the power storage source 16 supplies power to the control circuit 15 for the security electric motor 3. In the security loosening operation, the electromagnetic clutch 7 is turned on. In the security loosening operation, the regular electric motor 2 is not driven. In the security loosening operation, the electromagnetic brake 6 is turned off. In the security loosening operation, the security electric motor 3 is capable of forward rotation or reverse rotation (the rotation in the loosening direction) with the supplied electric power. The rotation in the loosening direction is the rotation in the opposite direction to the braking direction.

The forward or reverse rotation of the security electric motor 3 is transmitted to the brake mechanism 5 through the electromagnetic clutch 7 and the shaft 4. For example, in the operation of loosening the parking braking, forward or reverse rotation of the security electric motor 3 loosens the braking (releases the braking force).

In the operation of loosening the parking braking, the parking braking is not necessarily loosened by only the driving force of the security electric motor 3. It is also possible to loosen the parking braking by only the driving force of the regular electric motor 2. Alternatively, in the operation of loosening the parking braking, it is also possible to loosen the parking braking by both driving forces of the regular electric motor 2 and the security electric motor 3.

<Manual Releasing of Parking Braking>

In the operation of manually releasing the parking braking, the security electric motor 3 may be driven. In the operation of manually releasing the parking braking, the power storage source 16 supplies power to the control circuit 15 for the security electric motor 3. In the operation of manually releasing the parking braking, the regular electric motor 2 is not driven. In the operation of manually releasing the parking braking, the power source 14 does not supply power to the control circuit 13 for the regular electric motor 2. In the operation of manually releasing the parking braking, the security electric motor 3 is capable of forward rotation or reverse rotation (the rotation in the loosening direction) with the supplied electric power.

The forward or reverse rotation of the security electric motor 3 is transmitted to the brake mechanism 5 through the electromagnetic clutch 7 and the shaft 4. For example, in the security braking operation, forward or reverse rotation of the security electric motor 3 loosens the braking (releases the braking force). In the operation of manually releasing the parking braking, after the braking is loosened, the security electric motor 3 is stopped.

In the operation of manually releasing the parking braking, a manual release mechanism of the electromagnetic brake 6 may be operated. For example, in the operation of manually releasing the parking braking, it is also possible to press a caliper body of the brake mechanism 5 or a push switch of a controller to loosen the parking braking.

<Strong Braking>

In the strong braking operation, both the regular electric motor 2 and the security electric motor 3 are driven. In the strong braking operation, the power source 14 supplies power to the control circuit 13 for the regular electric motor 2. In the strong braking operation, the power source 14 supplies power to the control circuit 15 for the security electric motor 3. In the strong braking operation, the electromagnetic clutch 7 is turned on. In the strong braking operation, the electromagnetic brake 6 is turned off. In the strong braking operation, the regular electric motor 2 is capable of forward rotation and reverse rotation (the rotation in the tightening direction) with the supplied electric power. The rotation in the tightening direction is the rotation in the same direction as the braking direction. In the strong braking operation, the security electric motor 3 is capable of forward rotation and reverse rotation (the rotation in the tightening direction) with the supplied electric power.

The forward and reverse rotation of the regular electric motor 2 is transmitted to the brake mechanism 5 through the shaft 4. In addition, the forward and reverse rotation of the security electric motor 3 is transmitted to the brake mechanism 5 through the electromagnetic clutch 7 and the shaft 4. For example, in the strong braking operation, both forward rotation of the regular electric motor 2 and forward rotation of the security electric motor 3 tighten the braking (apply the braking force). Thus, in the strong braking operation, a stronger braking force can be applied than in the normal braking operation.

In the strong braking operation, to retain the braking (such as for parking braking), the regular electric motor 2 and the security electric motor 3 are stopped with a predetermined amount of braking force applied. In the strong braking operation, to retain the braking, the electromagnetic clutch 7 is turned off, and the electromagnetic brake 6 is turned on. This disconnects the transmission of the rotational force of the security electric motor 3 and locks the rotation of the regular electric motor 2. When loosening the braking, a strong force is basically not necessary, and thus the braking may be loosened by the driving force of either one of the regular electric motor 2 and the security electric motor 3.

### Advantageous Effects

As described above, the brake device 1 for a railway vehicle according to this embodiment includes: a regular electric motor 2 having a rotatable regular-side rotor 2b; a transmission shaft member 4 extending from the regular electric motor 2 in the direction of the rotation axis of the regular-side rotor 2b and rotated by the rotational force output from the regular-side rotor 2b; a conversion mechanism 30 attached to the transmission shaft member 4 and configured to convert the rotational motion of the transmission shaft member 4 into linear motion; friction members 40A and 40B configured to receive the linear motion to be pressed against a brake-applied member 41 of the railway vehicle, so as to brake the railway vehicle; and a security power unit 3 attached to the transmission shaft member 4 and configured to output the rotational force to the transmission shaft member 4.

With this configuration, the regular electric motor 2 and the security power unit 3 are provided to achieve the redundancy of the brake device 1 for a railway vehicle. In addition, only one transmission shaft member 4 is needed to transmit the output of the regular electric motor 2 and the security power unit 3 to the conversion mechanism 30. Therefore, as compared to the case where a gear mechanism including gears is interposed, there is no effect of backlash and inertia of the gear mechanism. This makes it possible to improve the response of the braking force and the transmission efficiency for the driving force of the regular electric motor 2 and the security power unit 3 transmitted to the friction members 40A and 40B.

The transmission shaft member 4 according to this embodiment extends from the regular electric motor 2 in two coaxial directions. The conversion mechanism 30 and the security power unit 3 are arranged coaxially with the transmission shaft member 4 and located on opposite sides across the regular electric motor 2. With this configuration, it is easier to attach or detach (e.g., as an option) the security power unit 3 than in the case where the conversion mechanism and the security power unit 3 are provided on the same side of the transmission shaft member 4 extending from the regular electric motor 2.

The brake device 1 for a railway vehicle includes the clutch 7 configured to switch between a transmission state in which the rotational force of the security power unit 3 is transmitted to the transmission shaft member 4 and a non-transmission state in which the rotational force of the security power unit 3 is not transmitted to the transmission shaft member 4. The clutch 7 is provided between the regular electric motor 2 and the security power unit 3. With this configuration, the switching operation of the clutch 7 prevents the security power unit 3 from being rotated. In addition, space for the clutch 7 can be provided between the regular electric motor 2 and the security power unit 3.

The security power unit 3 according to this embodiment is a motor including a security-side rotor 3b having a hollow structure and configured to output a rotational force. The clutch 7 is coupled to the security-side rotor 3b and the transmission shaft member 4. The clutch 7 includes a clutch-side rotor 7b and an armature 7c that can move relative to the clutch-side rotor 7b. The clutch 7 is an electromagnetic clutch configured to switch between a contact state in which the armature 7c is in contact with the clutch-side rotor 7b and a non-contact state in which the armature 7c is not in contact with the clutch-side rotor 7b. The security-side rotor 3b is fixed to the armature 7c. The clutch-side rotor 7b has a smaller weight than the security-side rotor 3b. With this configuration, even when driving of the regular electric motor 2 causes rotation of the clutch-side rotor 7b, the output loss of the regular electric motor 2 can be reduced, as compared to the case where the clutch-side rotor 7b has a larger weight than the security-side rotor 3b.

The regular-side rotor 2b according to this embodiment has a hollow structure. The transmission shaft member 4 extends through the regular-side rotor 2b having a hollow structure, and the transmission shaft member 4 is coupled with the regular-side rotor 2b to be driven. With this configuration, the shaft shape of the transmission shaft member 4 can be designed independently of the design of the regular electric motor 2.

The brake device 1 for a railway vehicle according to this embodiment includes an electromagnetic brake 6 for retaining the braking force. The electromagnetic brake 6 is provided between the regular electric motor 2 and the security power unit 3. This configuration allows the brake force to be retained without the need for gears.

The transmission shaft member 4 according to this embodiment extending from the regular electric motor 2 is fixed to the clutch-side rotor 7b. The security power unit 3 is fixed to the armature 7c. The brake device 1 for a railway vehicle according to this embodiment includes an input gear 70 to which the output of the regular electric motor 2 is input, and a speed reducer 20 that receives the rotation of the input gear 70 and outputs a decelerated rotational force to the conversion mechanism 30. The transmission shaft member 4 extending from the regular electric motor 2 is fixed to the input gear 70.

The transmission shaft member 4 according to this embodiment is a shaft fixed to the regular-side rotor 2b. The brake device 1 for a railway vehicle according to this embodiment includes an input gear 70 fixed to the shaft 4 extending from the regular electric motor 2 and configured to receive the output of the regular electric motor 2, and a speed reducer 20 having an output rotator 21 that receives the rotation of the input gear 70 and outputs a decelerated rotational force. The conversion mechanism 30 includes a male screw 31 serving as an input rotator 31 to which the rotational force output from the output rotator 21 is input, a female screw 32 serving as a linear motion member that converts the rotational motion of the male screw 31 into linear motion and meshing with the male screw 31, and arms 33A and 33B that transmit the linear motion output by the female screw 32 to the friction members 40A and 40B.

### Second Embodiment

<Brake Device for Railway Vehicle>

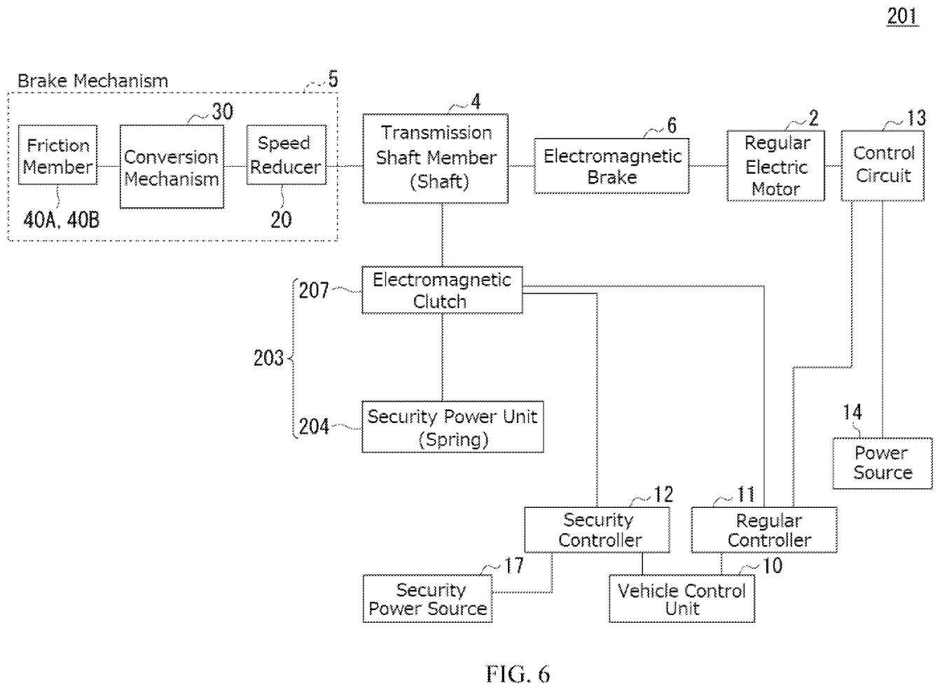

FIG. 6 is a block diagram showing a brake device 201 for a railway vehicle according to a second embodiment. In the first embodiment described above, the security power unit is a DC electric motor, but this example is not limitative. For example, the security power unit may be a spring cylinder. As shown in FIG. 6, the security power unit 203 of the second embodiment includes a spring 204 and a retention mechanism 207 that retains the spring 204 in a biased state. The first and second embodiments have some common features, which have the same name and will not be described in detail.

For example, the regular controller 11 controls the rotational drive of the regular electric motor 2 via the control circuit 13. For example, the regular controller 11 controls the electromagnetic clutch 207 (an example of the retention mechanism) included in the security power unit 203. For example, the security controller 12 controls the electromagnetic clutch 207 included in the security power unit 203. The spring 204 included in the security power unit 203 serves as a drive energy source for the security braking and the parking braking in the event of power loss. For example, the spring 204 is a spiral spring.

<Example of Braking Operation>

Next, an example of braking operation of the brake device for a railway vehicle according to the second embodiment is described with reference to FIG. 6 and other drawings.

<Normal Braking>

In the normal braking operation, the regular electric motor 2 is driven. In the normal braking operation, the power source 14 supplies power to the control circuit 13 for the regular electric motor 2. In the normal braking operation, the electromagnetic clutch 207 is turned off. In the normal braking operation, the security power unit 203 is not driven. In the normal braking operation, the spring 204 of the security power unit 203 is retained in a biased state so that it can operate in an emergency.

When the regular electric motor 2 is driven, the electromagnetic brake 6 is turned off. When the regular electric motor 2 is driven, the electromagnetic brake 6 does not lock the rotation of the regular electric motor 2. The regular electric motor 2 is capable of forward and reverse rotation with the supplied electric power. The forward and reverse rotation of the regular electric motor 2 is transmitted to the brake mechanism 5 through the shaft 4. For example, in the normal braking operation, forward rotation of the regular electric motor 2 tightens the braking, and reverse rotation thereof loosens the braking. In the normal braking operation, to retain the braking (such as for parking braking), the regular electric motor 2 is stopped with a predetermined amount of braking force applied.

<Security Braking>

In the security braking operation, the security power unit 203 is driven. In the security braking operation, the spring 204 of the security power unit 203 is released from the biased state. In the security braking operation, the electromagnetic clutch 207 is turned on. In the security braking operation, the regular electric motor 2 is not driven. In the security braking operation, the power source 14 does not supply power to the control circuit 13 for the regular electric motor 2.

When the spring 204 is released from the biased state, the electromagnetic brake 6 is turned off. When the spring 204 is released from the biased state, the electromagnetic brake 6 does not lock the rotation of the regular electric motor 2. The security power unit 203 is capable of rotating in one direction when the spring 204 is released from the biased state. The rotation in one direction of the security power unit 203 is the rotation in one direction around the output shaft of the security power unit 203.

The rotation in one direction of the security power unit 203 is transmitted to the brake mechanism 5 through the electromagnetic clutch 207 and the shaft 4. For example, in the security braking operation, the rotation in one direction of the security power unit 203 tightens the braking (applies the braking force). In the security braking operation, to retain the braking (such as for parking braking), the security power unit 203 (e.g., the electromagnetic clutch 207) is stopped with a predetermined amount of braking force applied.

<Energy Charging>

In the operation of energy charging, the regular electric motor 2 is driven. In the operation of energy charging, the power source 14 supplies power to the control circuit 13 for the regular electric motor 2. In the operation of energy charging, the spring 204 is put into a biased state. This allows the security power unit 203 to be driven in an emergency.

In the operation of energy charging, the vehicle control unit 10 puts the spring 204 into the biased state by controlling the electromagnetic brake 6 and the electromagnetic clutch 207 and driving the regular electric motor 2. The regular electric motor 2 is capable of forward rotation or reverse rotation (the rotation in the braking direction) with the supplied electric power.

The forward rotation or the reverse rotation (the rotation in the braking direction) of the regular electric motor 2 is transmitted to the brake mechanism 5 through the electromagnetic brake 6 and the shaft 4. In the operation of energy charging, the rotation in the braking direction of the regular electric motor 2 tightens the braking (applies the braking force).

In the operation of energy charging, the electromagnetic brake 6 is turned off. In the operation of energy charging, the electromagnetic brake 6 does not lock the rotation of the regular electric motor 2. In the operation of energy charging, the electromagnetic clutch 207 is turned on. In the operation of energy charging, the forward or reverse rotation of the regular electric motor 2 is transmitted to the spring 204 through the shaft 4 and the electromagnetic clutch 207. As a result, the spring 204 is put into the biased state.

In the operation of energy charging, a sensor may be used to sense the force of the spring 204 or the electric current value of the regular electric motor 2. For example, the vehicle control unit 10 may stop the spring 204 at a predetermined position to prevent the spring 204 from being biased excessively, based on the sensing results of the force of the spring 204 and the electric current value of the regular electric motor 2.

<Return Operation>

In the return operation, the regular electric motor 2 may be driven. The return operation is to move the friction members 40A and 40B away from the brake-applied member 41. In the return operation, the power source 14 supplies power to the control circuit 13 for the regular electric motor 2. In the return operation, the spring 204 is put into a biased state. This allows the security power unit 203 to be driven in an emergency.

When the regular electric motor 2 is driven, the electromagnetic brake 6 is turned off. When the regular electric motor 2 is driven, the electromagnetic brake 6 does not lock the rotation of the regular electric motor 2. The regular electric motor 2 is capable of forward rotation and reverse rotation (the rotation in the loosening direction) with the supplied electric power. The forward rotation or the reverse rotation (the rotation in the loosening direction) of the regular electric motor 2 is transmitted to the brake mechanism 5 through the shaft 4. For example, in the return operation, the rotation in the loosening direction of the regular electric motor 2 loosens the braking (releases the braking force). In the return operation, after the braking is loosened (after the friction members 40A and 40B are moved away from the brake-applied member 41), the regular electric motor 2 is stopped.

<Manual Releasing of Parking Braking>

In the operation of manually releasing the parking braking, the rotating shaft of the security power unit 203 may be disconnected manually. In the operation of manually releasing the parking braking, the spring 204 of the security power unit 203 is released fully from the biased state. In the operation of manually releasing the parking braking, the regular electric motor 2 is not driven. In the operation of manually releasing the parking braking, the power source 14 does not supply power to the control circuit 13 for the regular electric motor 2.

When the spring 204 is released fully from the biased state, the electromagnetic brake 6 is turned off. When the spring 204 is released fully from the biased state, the electromagnetic brake 6 does not lock the rotation of the regular electric motor 2. The security power unit 203 is capable of rotating in one direction when the spring 204 is released fully from the biased state. In the operation of manually releasing the parking braking, the rotating shaft of the security power unit 203 is disconnected, and thus the rotation in one direction of the spring 204 does not act on the brake mechanism 5. In the operation of manually releasing the parking braking, the braking is loosened because the reaction force acting on the brake mechanism 5 is released.

For example, in the operation of manually releasing the parking braking, a spring clutch or other means may be used to disconnect the rotating shaft of the security power unit 203. For example, the braking may be loosened by turning a mechanical switch by hand while the parking braking is applied. For example, the output shaft of the security power unit 203 may be turned with a wrench or other tool. For example, the shaft may be disconnected between the electromagnetic clutch 207 and the security power unit 203. After manually releasing the parking braking, charging is performed (spring 204 is retained in a biased state) when the power is turned on.

### Advantageous Effects

As described above, the security power unit 203 according to the embodiment includes a spring 204 and an electromagnetic clutch 207 serving as a retention mechanism that retains the spring 204 in a biased state. The vehicle control unit 10 puts the spring 204 into the biased state by controlling the electromagnetic brake 6 and the electromagnetic clutch 207 and driving the regular electric motor 2. With this configuration, the spring 204 can be put into the biased state under the control of the vehicle control unit 10 (automatically), without manual application of a force.

### Third Embodiment

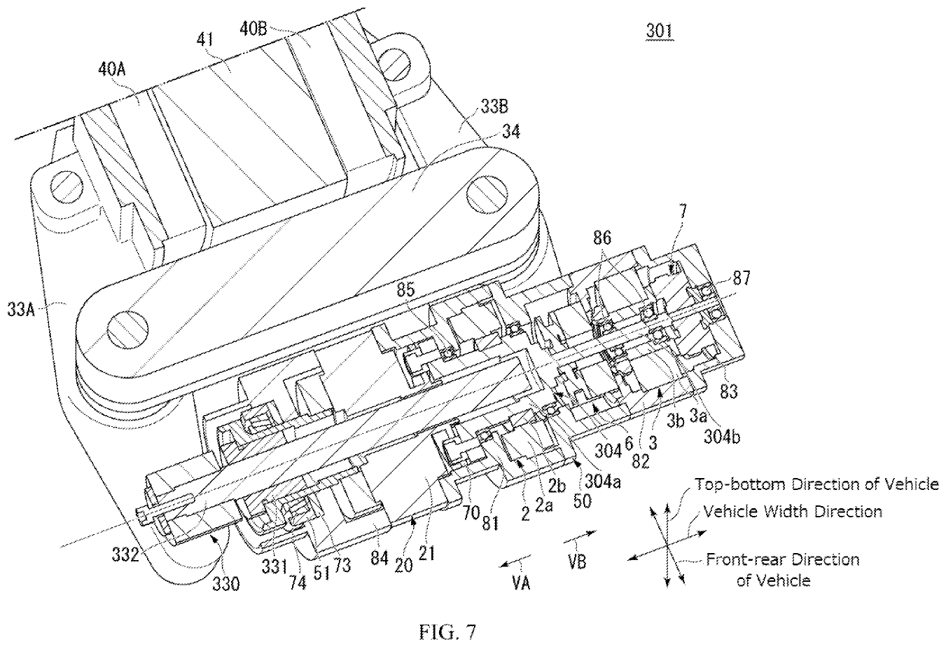

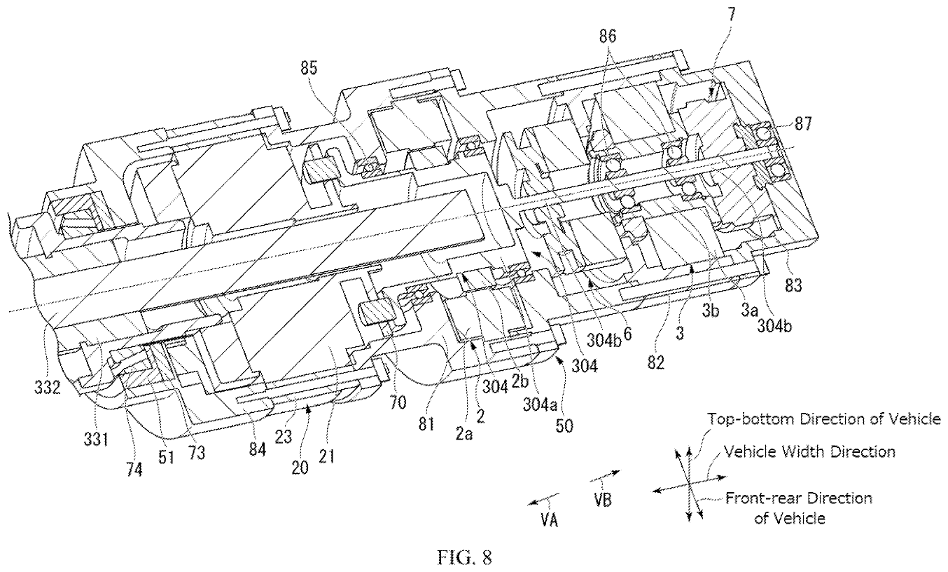

FIG. 7 is a cross-sectional perspective view schematically showing the brake device 301 for a railway vehicle according to the third embodiment. FIG. 8 is a cross-sectional perspective view showing a coupling unit 304 of the third embodiment and surrounding parts. In the first embodiment described above, the transmission shaft member is the shaft 4 fixed to the regular-side rotor 2b, but this example is not limitative. For example, as shown in FIG. 7, the transmission shaft member may be the coupling unit 304 having a tubular shape and fixed to the regular-side rotor 2b. The first and third embodiments have some common features, which have the same name and will not be described in detail.

An input gear 70 to which the output of the regular electric motor 2 is input is fixed to the coupling unit 304 extending from the regular electric motor 2. The speed reducer 20 includes an output rotator 21 that receives the rotation of the input gear 70 and outputs a decelerated rotational force. The conversion mechanism 330 includes an input rotator 331 to which the rotational force output from the output rotator 21 is input, a linear motion member 332 that converts the rotational motion of the input rotator 331 into linear motion, and arms 33A and 33B that transmit the linear motion generated through conversion by the linear motion member 332 to the friction members 40A and 40B. The linear motion member 332 converts the rotational motion of the input rotator 331 into linear motion in the moving directions VA and VB parallel to the rotation axis of the input rotator 331. In this embodiment, the conversion mechanism 330 is a ball screw mechanism. The input rotator 331 is a female screw 331. The linear motion member 332 is a male screw 332 that meshes with the female screw 331.

The coupling unit 304 houses the portion of the male screw 332 on one side in the vehicle width direction. The coupling unit 304 extends from the regular electric motor 2 in two coaxial directions. The coupling unit 304 includes a tube portion 304a and a shaft portion 304b. The tube portion 304a has a tubular shape and houses the male screw 332, and the shaft portion 304b extends from the radially middle portion of the tube portion 304a toward one side in the vehicle width direction.

The conversion mechanism 330 includes a pair of arms 33A and 33B (the first arm 33A and the second arm 33B) that transmit the linear motion, which is the output of the male screw 332, to the friction members 40A and 40B. The first arm 33A extends along the front-rear direction of the vehicle so as to connect between the first friction member 40A and the portion of the male screw 332 closer to the end opposite to the coupling unit 304. The first arm 33A has a length along the front-rear direction of the vehicle. One end of the first arm 33A in its longitudinal direction is coupled to the portion of the male screw 332 closer to the end opposite to the coupling unit 304 so as to be rotatable relative this portion of the male screw 332 about an axis along the top-bottom direction of the vehicle. The other end of the first arm 33A in its longitudinal direction is coupled to the first friction member 40A so as to be rotatable relative to the first friction member 40A about an axis along the top-bottom direction of the vehicle.

The second arm 33B extends along the front-rear direction of the vehicle so as to connect between the housing 50 and the second friction member 40B. The second arm 33B has a length along the front-rear direction of the vehicle. One end of the second arm 33B in its longitudinal direction is coupled to the housing 50 so as to be rotatable relative to the housing 50 about an axis along the top-bottom direction of the vehicle. The other end of the second arm 33B in its longitudinal direction is coupled to the second friction member 40B so as to be rotatable relative to the second friction member 40B about an axis along the top-bottom direction of the vehicle.

The coupling member 34 extends along the vehicle width direction so as to connect between the pair of arms 33A and 33B. The coupling member 34 has a length along the vehicle width direction. One end of the coupling member 34 in its longitudinal direction is coupled to the middle portion of the first arm 33A in its longitudinal direction so as to be rotatable relative to this middle portion of the first arm 33A about an axis along the top-bottom direction of the vehicle. The other end of the coupling member 34 in its longitudinal direction is coupled to the middle portion of the second arm 33B in its longitudinal direction so as to be rotatable relative to this middle portion of the second arm 33B about an axis along the top-bottom direction of the vehicle.

The brake device 301 for a railway vehicle includes a reaction force receiving member 51 that receives the reaction force acting on the female screw 331 when the friction members 40A and 40B are pressed against the brake-applied member 41. The reaction force receiving member 51 is provided between the female screw 331 and the housing 50. The end of the female screw 331 in the direction VB indicated by the arrow in the drawing is fixed to the output rotator 21. The female screw 331 is capable of transmitting the rotational motion of the output rotator 21 to the male screw 332.

For example, when the output of the regular electric motor 2 is input to the input gear 70, a decelerated rotational force is output from the output rotator 21 of the speed reducer 20. The rotational force output from the output rotator 21 is then input to the female screw 331. As described above, the rotational motion of the female screw 331 is converted into linear motion of the male screw 332 in the moving directions VA and VB.

The linear motion of the male screw 332 in the moving directions VA and VB is transmitted to the friction members 40A and 40B via the arms 33A and 33B and the coupling member 34. The arms 33A and 33B move in such a direction that the ends thereof coupled to the friction members 40A and 40B come closer to each other using the coupling member 34 as a fulcrum. As a result, the friction members 40A and 40B are pressed against the brake-applied member 41. Thus, the railway vehicle is braked.

### Advantageous Effects

The transmission shaft member 4 according to this embodiment is a coupling unit 304 having a tubular shape and fixed to the regular-side rotor 2b. The brake device 301 for a railway vehicle includes an input gear 70 fixed to the coupling unit 304 extending from the regular electric motor 2 and configured to receive the output of the regular electric motor 2, and a speed reducer 20 having an output rotator 21 that receives the rotation of the input gear 70 and outputs a decelerated rotational force. The conversion mechanism 330 includes a female screw 331 serving as an input rotator 331 to which the rotational force output from the output rotator 21 is input, a male screw 332 serving as a linear motion member that converts the rotational motion of the female screw 331 into linear motion and meshing with the female screw 331, and arms 33A and 33B that transmit the linear motion output by the male screw 332 to the friction members 40A and 40B. With this configuration, redundancy of the brake device 301 for a railway vehicle can be achieved with a coupling unit 304 having a tubular shape and fixed to the regular-side rotor 2b. In addition, only one transmission shaft member 304 (the coupling unit 304 as an integrated component formed of the tube portion 304a and the shaft portion 304b) is needed to transmit the output of the regular electric motor 2 and the security power unit 3 to the conversion mechanism 330. Therefore, as compared to the case where a gear mechanism including gears is interposed, there is no effect of backlash and inertia of the gear mechanism. This makes it possible to improve the response of the braking force and the transmission efficiency for the driving force of the regular electric motor 2 and the security power unit 3 transmitted to the friction members 40A and 40B.

The technical scope of the present invention is not limited to the embodiments described above but is susceptible of various modification within the purport of the present invention.

In the embodiments described above, the transmission shaft member extends from the regular electric motor in two coaxial directions, but this example is not limitative. For example, the transmission shaft member may extend from the regular electric motor in only one coaxial direction. For example, the aspect of the transmission shaft member extending from the regular electric motor may be changed in accordance with required specifications.

In the above embodiments, the conversion mechanism and the security power unit are arranged coaxially with the transmission shaft member and located on opposite sides across the regular electric motor, but this example is not limitative. The conversion mechanism and the security power unit need not be arranged coaxially with the transmission shaft member. For example, the conversion mechanism and the security power unit may be located on different axes than the transmission shaft member. For example, the conversion mechanism and the security power unit need not be located on opposite sides across the regular electric motor. For example, the conversion mechanism and the security power unit may be located on the same side of the regular electric motor. For example, the conversion mechanism and the security power unit can be arranged in various manners in accordance with required specifications.

In the embodiments described above, the electromagnetic brake is provided between the regular electric motor and the security power unit, but this example is not limitative. For example, the electromagnetic brake need not be provided between the regular electric motor and the security power unit. For example, the electromagnetic brake may be provided between the regular electric motor and the speed reducer. For example, the electromagnetic brake can be arranged in various manners in accordance with required specifications.

In the embodiments described above, the electromagnetic clutch is provided between the regular electric motor and the security power unit, but this example is not limitative. For example, the electromagnetic clutch need not be provided between the regular electric motor and the security power unit. For example, the electromagnetic clutch may be provided on the opposite side to the regular electric motor across the security power unit. For example, the electromagnetic clutch can be arranged in various manners in accordance with required specifications.

In the embodiments described above, the regular-side rotor has a hollow structure, but this example is not limitative. For example, the regular-side rotor may have a solid structure. For example, the transmission shaft member may be coupled to the regular-side rotor having a solid structure. For example, the regular-side rotor can be configured and the transmission shaft member can be arranged in various manners in accordance with required specifications.

In the embodiments described above, when the security power unit is an AC electric motor (an example of an electric motor), the security-side rotor has a hollow structure, but this example is not limitative. For example, the security-side rotor may have a solid structure. For example, the security-side rotor may be coupled to the transmission shaft member via a power transmission mechanism such as a gear mechanism. For example, the security-side rotor can be configured and the transmission shaft member can be arranged in various manners in accordance with required specifications.

In the embodiments described above, when the security power unit is an AC electric motor (an example of an electric motor), the clutch-side rotor has a smaller weight than the security-side rotor, but this example is not limitative. For example, the clutch-side rotor may have a larger weight than the security-side rotor. For example, the relationship in weight between the clutch-side rotor and the security-side rotor can be modified in accordance with required specifications.

In the embodiments described above, the conversion mechanism is a ball screw mechanism, but this example is not limitative. For example, if the conversion mechanism is not a ball screw mechanism, it may include a belt pulley mechanism that transmits power with a belt stretched between pulleys. For example, the conversion mechanism can be configured in various manners in accordance with required specifications.

In the embodiments described above, the speed reducer includes an eccentric oscillation gear mechanism, but this example is not limitative. For example, the speed reducer may include a planetary gear mechanism. For example, the speed reducer may be a harmonic speed reducer. For example, the speed reducer can be configured in various manners in accordance with required specifications.

In the embodiments described above, the electromagnetic brake and the electromagnetic clutch are controlled electrically, but this example is not limitative. For example, the brake device may include a mechanical brake mechanism and clutch mechanism. For example, the brake device may mechanically lock the rotation of a rotor without control. For example, it is also possible that the brake device does not include at least one of the electromagnetic brake and the electromagnetic clutch. For example, the electromagnetic brake and the electromagnetic clutch can be controlled and arranged in various manners in accordance with required specifications.

In the embodiments described above, the security power unit is an AC electric motor (an example of an electric motor), or the security power unit includes a spring and a retention mechanism, but these examples are not limitative. For example, the security power unit may be an air cylinder driven by compressed air or an air motor. The security power unit can be configured in various manners in accordance with required specifications.

In the embodiments described above, a pair of friction members constitute a disc brake unit (DBU) that sandwiches the disc as the brake-applied member on both sides (disc braking system), but this example is not limitative. For example, the brake device may constitute a tread brake unit (TBU) in which a friction member is pressed against the tread of a wheel as the brake-applied member on one side (wheel tread braking system). For example, the aspect of the braking system can be modified in accordance with required specifications.

The elements of the embodiments described above may be replaced with known elements within the purport of the present invention. Further, the modifications described above may be combined. In the embodiments disclosed herein, a member formed of multiple components may be integrated into a single component, or conversely, a member formed of a single component may be divided into multiple components. Irrespective of whether or not the components are integrated, they are acceptable as long as they are configured to attain the object of the invention.

What is claimed is:

1. A brake device for a railway vehicle, comprising:
a regular electric motor including a regular-side rotor capable of rotating; a transmission shaft member extending from the regular electric motor in a direction of a rotation axis of the regular-side rotor and configured to be rotated by a rotational force output from the regular-side rotor;
a conversion mechanism attached to the transmission shaft member and configured to convert rotational motion of the transmission shaft member into linear motion;
a friction member configured to receive the linear motion to be pressed against a brake-applied member of a railway vehicle, so as to brake the railway vehicle; and
a security power unit attached to the transmission shaft member and configured to output a rotational force to the transmission shaft member.

2. The brake device for a railway vehicle according to claim 1,
wherein the transmission shaft member extends from the regular electric motor in two coaxial directions, and
wherein the conversion mechanism and the security power unit are arranged coaxially with the transmission shaft member and located on opposite sides across the regular electric motor.

3. The brake device for a railway vehicle according to claim 2, further comprising:
a clutch configured to switch between a transmission state in which a rotational force of the security power unit is transmitted to the transmission shaft member and a non-transmission state in which a rotational force of the security power unit is not transmitted to the transmission shaft member,
wherein the clutch is provided between the regular electric motor and the security power unit.

4. The brake device for a railway vehicle according to claim 3,
wherein the security power unit is a motor including a security-side rotor having a hollow structure and configured to output a rotational force, and
wherein the clutch is coupled to the security-side rotor and the transmission shaft member.

5. The brake device for a railway vehicle according to claim 4,
wherein the clutch is an electromagnetic clutch including a clutch-side rotor and an armature capable of moving relative to the clutch-side rotor, the clutch being configured to switch between a contact state in which the armature is in contact with the clutch-side rotor and a non-contact state in which the armature is not in contact with the clutch-side rotor, and
wherein the security-side rotor is fixed to the armature.

6. The brake device for a railway vehicle according to claim 5, wherein the clutch-side rotor has a smaller weight than the security-side rotor.

7. The brake device for a railway vehicle according to claim 1,
wherein the regular-side rotor has a hollow structure, and
wherein the transmission shaft member extends through the regular-side rotor having a hollow structure, and the transmission shaft member is coupled with the regular-side rotor to be driven.

8. The brake device for a railway vehicle according to claim 1, further comprising:
an electromagnetic brake for retaining a braking force,
wherein the electromagnetic brake is provided between the regular electric motor and the security power unit.

9. The brake device for a railway vehicle according to claim 1, further comprising:
a clutch configured to switch between a transmission state in which a rotational force of the security power unit is transmitted to the transmission shaft member and a non-transmission state in which a rotational force of the security power unit is not transmitted to the transmission shaft member,
wherein the clutch is an electromagnetic clutch including a clutch-side rotor and an armature capable of moving relative to the clutch-side rotor, the clutch being configured to switch between a contact state in which the armature is in contact with the clutch-side rotor and a non-contact state in which the armature is not in contact with the clutch-side rotor, and
wherein the transmission shaft member extending from the regular electric motor is fixed to the clutch-side rotor.

10. The brake device for a railway vehicle according to claim 1, further comprising:
a clutch configured to switch between a transmission state in which a rotational force of the security power unit is transmitted to the transmission shaft member and a non-transmission state in which a rotational force of the security power unit is not transmitted to the transmission shaft member,
wherein the clutch is an electromagnetic clutch including a clutch-side rotor and an armature capable of moving relative to the clutch-side rotor, the clutch being configured to switch between a contact state in which the armature is in contact with the clutch-side rotor and a non-contact state in which the armature is not in contact with the clutch-side rotor, and
wherein the security power unit is fixed to the armature.

11. The brake device for a railway vehicle according to claim 1, further comprising:
an input gear configured to receive an output of the regular electric motor; and
a speed reducer configured to receive rotation of the input gear and output a decelerated rotational force to the conversion mechanism,
wherein the transmission shaft member extending from the regular electric motor is fixed to the input gear.

12. The brake device for a railway vehicle according to claim 1,
wherein the transmission shaft member is a shaft fixed to the regular-side rotor,
wherein the brake device further comprises:
an input gear fixed to the shaft extending from the regular electric motor, the input gear being configured to receive an output of the regular electric motor; and
a speed reducer including an output rotator configured to receive rotation of the input gear and output a decelerated rotational force, and
wherein the conversion mechanism includes:
a male screw serving as an input rotator configured to receive a rotational force output from the output rotator;
a female screw meshing with the male screw, the female screw serving as a linear motion member configured to convert rotational motion of the male screw into the linear motion; and
an arm configured to transmit to the friction member the linear motion output from the female screw.

13. The brake device for a railway vehicle according to claim 1,
wherein the transmission shaft member is a coupling unit having a tubular shape and fixed to the regular-side rotor,
wherein the brake device further comprises:
an input gear fixed to the coupling unit extending from the regular electric motor, the input gear being configured to receive an output of the regular electric motor; and
a speed reducer including an output rotator configured to receive rotation of the input gear and output a decelerated rotational force, and
wherein the conversion mechanism includes:
a female screw serving as an input rotator configured to receive a rotational force output from the output rotator;
a male screw meshing with the female screw, the male screw serving as a linear motion member configured to convert rotational motion of the female screw into the linear motion; and
an arm configured to transmit to the friction member the linear motion output from the male screw.
